(19) United States
(12) Patent Application Publication
(10) Pub. No.: US 2019/0095701 A1
(43) Pub. Date: Mar. 28, 2019

(54) LIVING-BODY DETECTION METHOD, DEVICE AND STORAGE MEDIUM

(71) Applicant: Lenovo (Beijing) Co., Ltd., Beijing (CN)

(72) Inventor: Hao LI, Beijing (CN)

(21) Appl. No.: 16/143,860

(22) Filed: Sep. 27, 2018

(30) Foreign Application Priority Data
Sep. 27, 2017 (CN) 201710892104.1

(51) Int. Cl. G06K 9/00; G06K 9/62; G06T 7/13

(52) U.S. Cl. CPC G06K 9/00281; G06K 9/6269; G06K 9/00288; G06T 2207/20081; G06T 2207/10036; G06T 2207/30201; G06T 7/13

(57) ABSTRACT

A method of detecting a target object includes acquiring an image of a test object using a preset light spectrum, identifying the test object from the acquired image of the test object, determining a feature region of the test object from the acquired image of the test object, obtaining light reflection information of the test object, and detecting whether the test object is the target object based on the feature region and the light reflection information.

### CROSS-REFERENCES TO RELATED APPLICATIONS

This application claims the priority of Chinese patent application No. 201710892104.1, filed on Sep. 27, 2017, the entire content of which is incorporated herein by reference.

### FIELD OF THE DISCLOSURE

The present disclosure generally relates to the field of face recognition technology and, more particularly, relates to a living-body detection method, device and storage medium.

### BACKGROUND

Face recognition is a kind of biometric identification technology, which often uses image/video capture device to automatically detect and locate the position of a face in the captured image, and then performed the face recognition on the detected face.

As the face recognition technology widely spreads, various potential privacy concerns are also gradually exposed, such as using face photos, face video clips or imitated three-dimensional face mold to deceive face recognition system. To prevent such potential fraudulent attacks, existing methods often determine a human face based on living-body movement information. For example, a user is prompted to make a corresponding response such as blinking, shaking head and smiling. That is, the user has to perform certain interactions in the detection process. Thus, the detection time may be prolonged, and the detection efficiency may be substantially low.

The disclosed living-body detection method, device and storage medium are directed to solve one or more problems set forth above and other problems.

### BRIEF SUMMARY OF THE DISCLOSURE

One aspect of the present disclosure provides a method of detecting a target object including acquiring an image of a test object using a preset light spectrum, identifying the test object from the acquired image of the test object, determining a feature region of the test object from the acquired image of the test object, obtaining light reflection information of the test object, and detecting whether the test object is the target object based on the feature region and the light reflection information.

Another aspect of the present disclosure provides a detection device configured to detect a target object and including an image capturing device and a processor coupled to the image capturing device. The image capturing device is configured to acquire an image of a test object using a preset light spectrum and obtain light reflection information of the test object. The processor is configured to identify the test object from the acquired image of the test object, determine a feature region of the test object from the acquired image of the test object, obtain light reflection information of the test object, and detect whether the test object is the target object based on the feature region and the light reflection information.

Another aspect of the present disclosure provides a non-transitory computer-readable medium storing a computer program that, when being executed by a processor, causes the processor to perform a method of detecting a target object. The method includes acquiring an image of a test object using a preset light spectrum, identifying the test object from the acquired image of the test object, determining a feature region of the test object from the acquired image of the test object, obtaining light reflection information of the test object, and detecting whether the test object is the target object based on the feature region and the light reflection information.

Other aspects of the present disclosure may be understood by those skilled in the art in light of the description, the claims, and the drawings of the present disclosure.

### BRIEF DESCRIPTION OF THE DRAWINGS

To more clearly illustrate technical solutions of embodiments or in the prior art, accompany drawings which need to be used in the description of the embodiments or the prior art will be simply introduced. Obviously, the accompany drawings in the following description are merely some embodiments, and for those of ordinary skill in the art, other embodiments can further be obtained according to these accompany drawings without contributing any creative work.

FIG. 1 illustrates a flow chart of an exemplary living-body detection method consistent with disclosed embodiments;

FIG. 2 illustrates an exemplary living-body detection/information security consistent with disclosed embodiments;

FIG. 3 illustrates a flow chart of another exemplary living-body detection method consistent with disclosed embodiments;

FIG. 4 illustrates a flow chart of another exemplary living-body detection method consistent with disclosed embodiments;

FIG. 5 illustrates a flow chart of another exemplary living-body detection method consistent with disclosed embodiments;

FIG. 6 illustrates an exemplary living-body detection system consistent with disclosed embodiments; and

FIG. 7 illustrates another exemplary living-body detection system consistent with disclosed embodiments.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted. It should be noted that the relative arrangement of the components and steps, the numerical expressions, and numerical values set forth in the exemplary embodiments do not limit the scope of the present disclosure unless it is specifically stated otherwise.

Further, in the present disclosure, the disclosed embodiments and the features of the disclosed embodiments may be combined under conditions without conflicts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

The present disclosure provides a living-body detection method, which may be applied to a living-body detection device, such as a face recognition access and attendance system, a face recognition security door, and a face recognition payment system, etc. The face recognition payment system may include a smart electronic device having face recognition and payment functions, such as a smart phone, a computer, a tablet and other electronic devices.

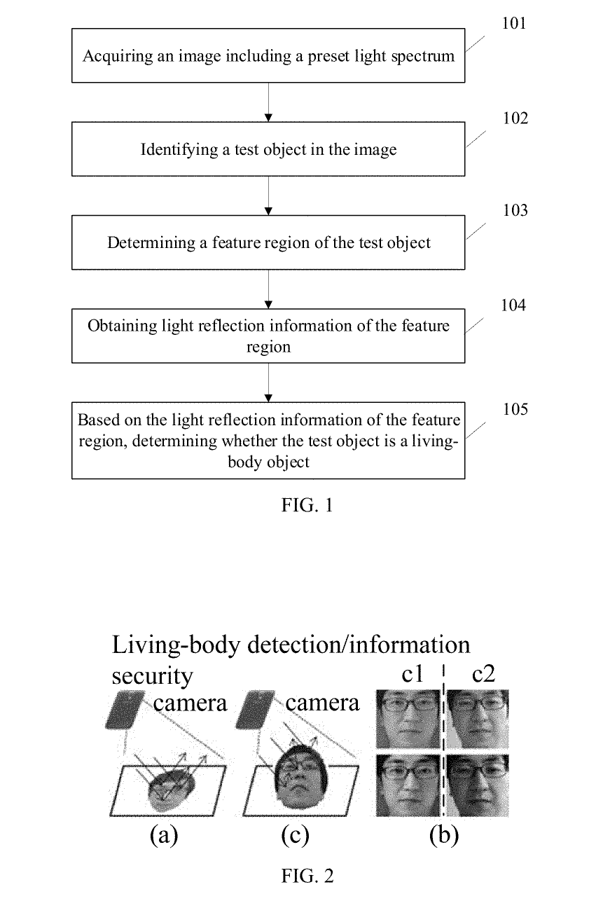

FIG. 1 illustrates a flow chart of an exemplary living-body detection method consistent with disclosed embodiments. As shown in FIG. 1, the method living-body detection may comprise:

Step 101: acquiring an image including a preset light spectrum;

Step 102: identifying a test object in the image;

Step 103: determining a feature region of the test object;

Step 104: obtaining light reflection information of the feature region; and

Step 105: based on the light reflection information of the feature region, determining whether the test object is a living-body object.

In the Step 101, an image including a preset light spectrum may be acquired. For example, the image can be acquired using the preset light spectrum. The image can be an image of the test object. The preset light spectrum may include, but not limited to, a band of 550 nm, 685 nm and 850 nm.

For the above-mentioned band of 550 nm, 685 nm and 850 nm, a special “W” mode may be observed in the skin reflection curve near the 550 nm band due to the special substances such as skin melanin. The observed “W” mode may be associated with the light reflectivity of the skin, which may effectively prompt the skin recognition (e.g., differentiate materials that mimic the color of human skin), and help to model and render human skin in a more realistic way. The band of 850 nm may be desired for living-body detection. The band of 685 nm may facilitate the classification of different ethnic groups.

In one embodiment, the image including the preset light spectrum may be acquired by a camera in a living-body detection device. For example, a user may record a multispectral image containing at least the band of 550 nm and 850 nm through an electronic device. For another example, a face recognition access and attendance system or a face recognition security door may acquire a multispectral image including at least the band of 550 nm and 850 nm.

In one embodiment, to improve the detection efficiency, given the distance between an object to be determined and the living-body detection device satisfies a detection condition, for example, given the distance between the object to be determined and the living-body detection device is less than 1 meter (m), a camera in the living-body detection device camera may capture an image including a preset light spectrum, and deliver the captured image to a recognition system of the living-body detection device.

In the Step 102, a test object may be identified from the image. In one embodiment, the acquired image may contain various information such as human, animals, objects and backgrounds, and/or information representing such as human, animals, objects and backgrounds. Thus, after the image including the preset light spectrum is acquired, the recognition system in the living-body detection device may detect or identify the object in the image, to obtain a test object satisfying a detection condition.

For example, after the camera in the living-body detection device acquires an image which contains a human or an object representing a human, a dog and a background, the dog and the background in the image may be considered as useless objects. To obtain a useful object, various information in the image may be detected or identified to obtain the information of the human or the information of the object representing the human in the image.

In the Step 103, a feature region of the test object may be determined. In one embodiment, after the test object is identified in the image, a feature region of the test object may be determined. For example, the feature region may include the entire head region of the test object or a certain feature region of the head, such as the forehead, eyes, nose, lips, eyebrow, chin, ears, and face edge.

In the Step 104, light reflection information of the test object, e.g., light reflection information of the feature region, may be obtained. The light reflection information may include at least one of the light reflectivity or the light reflection direction. That is, the light reflection information may include at least one of a value of the light reflectivity or a direction of the light reflection. In particular, the light reflection information may at least include light reflection information at the bands of 550 nm and 850 nm.

Different materials or structures may have different light reflection information. For example, the light reflectivity of human skin differs from the light reflectivity of human skin mask, a human face in an electronic screen or an image. Further, for different parts of the human body, the light reflection angle may also be different and may be multi-dimensional. Other objects disguising a person, such as the electronic screen or photo showing a person, may have a light reflection angle significantly different from a living person.

Light reflection information may vary in different materials. In the process of capturing images, different feature regions may have different brightness. People having the same skin tone/color may have similar light reflection information. Thus, for the people having the same skin tone, the light reflection information may be processed, such as training the multi-dimensional light reflection information, to obtain a relatively uniform model capable of representing the real object. Accordingly, based on the light reflection information of different feature regions, whether the object is a living-body object may be determined.

In one embodiment, the light reflection information of at least one of the forehead, eyes, nose, lips, eyebrows, chin, ears and face edge may be obtained.

In the Step 105, based on the light reflection information of the feature region, whether the test object is a living-body object, also referred to as a “target object,” may be determined. In some embodiments, the determination may be based on at least one of the feature region or the light reflection information. In one embodiment, after obtaining the light reflection information of at least one of the forehead, eyes, nose, lips, eyebrows, chin, ears, or face edge, if the object is a living object, differences may exist between the light reflection information of different parts in the feature region and between the light reflection information of different materials in the feature region, according to which whether the test object is a living-body object may be determined.

FIG. 2 illustrates an exemplary living-body detection/information security consistent with disclosed embodiments. As shown in FIG. 2, a multispectral image containing a test object may be acquired by a camera. As shown in (a) of FIG. 2, during acquiring a multispectral image of a face in a photograph, because the face in the photograph is in a one-dimensional plane, the light reflection angle and light reflectivity in each area may be substantially the same. Thus, the grayscales in each area of the face in the captured image may be substantially consistent, as (c)-c1 of FIG. 2 shows. The images captured in (a) of FIG. 2 are shown in c1 of FIG. 2.

As shown in (b) of FIG. 2, due to the physiological structure of a living human face, different feature regions may have different light reflection angles and, accordingly, different feature regions may have different light reflectivity. Thus, multispectral images of different feature regions may present differences in darkness as (c)-c2 of FIG. 2 shows. The images captured in (b) of FIG. 2 are shown in c2 of FIG. 2. According to the presented differences in darkness, whether the test object is a living-body object may be determined.

In the disclosed embodiments, an image including a preset light spectrum may be acquired, a test object may be identified in the image, a feature region of the test object may be determined, and light reflection information of the feature region may be obtained. Based on the light reflection information of the feature region, whether the test object is a living-body object may be determined. The detection time may be effectively reduced, and the detection efficiency may be improved.

The present disclosure provides another living-body detection method, which may be applied to a living-body detection device, such as a face recognition access and attendance system, a face recognition security door, and a face recognition payment system, etc. The face recognition payment system may include a smart electronic device having face recognition and payment functions, such as a smart phone, a computer, a tablet and other electronic devices.

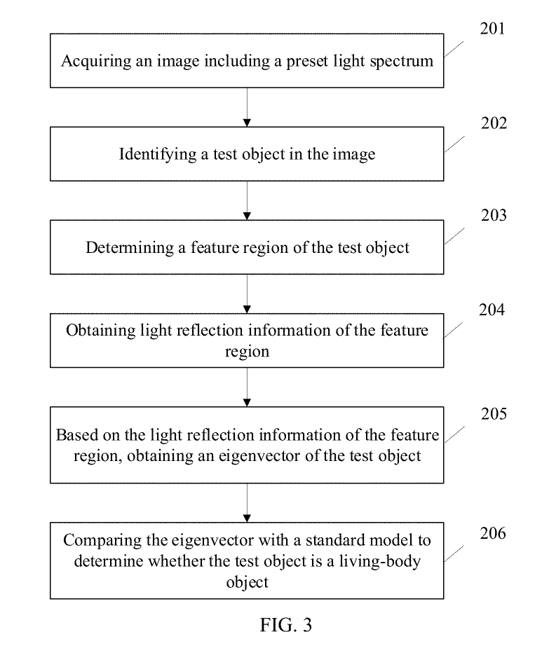

FIG. 3 illustrates a flow chart of another exemplary living-body detection method consistent with disclosed embodiments. As shown in FIG. 3, the method living-body detection may comprise:

Step 201: acquiring an image including a preset light spectrum;

Step 202: identifying a test object in the image;

Step 203: determining a feature region of the test object;

Step 204: obtaining light reflection information of the feature region;

Step 205: based on the light reflection information of the feature region, obtaining an eigenvector of the test object; and

Step 206: comparing the eigenvector with a standard model to determine whether the test object is a living-body object.

In the Step 201, an image including a preset light spectrum may be acquired. The preset light spectrum may include, but not limited to, a band of 550 nm, 685 nm, and/or 850 nm.

For the above-mentioned band of 550 nm, 685 nm and 850 nm, a special “W” mode may be observed in the skin reflection curve near the 550 nm band due to the special substances such as skin melanin. The observed “W” mode may be associated with the light reflectivity of the skin, which may effectively prompt the skin recognition (e.g., differentiate materials that mimic the color of human skin), and help to model and render human skin in a more realistic way. The band of 850 nm may be desired for living-body detection. The band of 685 nm may facilitate the classification of different ethnic groups.

In one embodiment, the image including the preset light spectrum may be acquired by a multispectral camera in a living-body detection device, such as a spectrum adjustable microelectromechanical system (MEMS) multispectral camera or a narrow-band multispectral imaging camera.

For example, the image including the preset light spectrum may be acquired by a camera in the living-body detection device. For example, a user may record a multispectral image containing at least the band of 550 nm and/or 850 nm through an electronic device. For another example, a face recognition access and attendance system or a face recognition security door may acquire a multispectral image including at least the band of 550 nm and 850 nm.

In one embodiment, to improve the detection efficiency, given the distance between an object to be determined and the living-body detection device satisfies a detection condition, for example, given the distance between the object to be determined and the living-body detection device is less than 1 meter (m), a camera in the living-body detection device camera may capture an image including a preset light spectrum, and deliver the captured image to a recognition system of the living-body detection device.

In the Step 202, a test object may be identified in the image. In one embodiment, the acquired image may contain various information such as human, animals, objects and backgrounds, and/or information representing such as human, animals, objects and backgrounds. Thus, after the image including the preset light spectrum is acquired, the recognition system in the living-body detection device may detect or identify the object in the image, to obtain a test object satisfying a detection condition.

For example, after the camera in the living-body detection device acquires the image which contains a human or an object representing a human, a dog and a background, the dog and the background in the image may be considered as useless objects. To obtain a useful object, various information in the image may be detected or identified to obtain the information of the human or the information of the object representing the human in the image.

In the Step 203, a feature region of the test object may be determined. In one embodiment, after the test object is identified in the image, a feature region of the test object may be determined. For example, the feature region may include the entire head region of the test object or a certain feature region of the head, such as the forehead, eyes, nose, lips, eyebrow, chin, ears, and face edge.

In the Step 204, light reflection information of the test object, e.g., light reflection information of the feature region, may be obtained. The light reflection information may include at least one of a value of the light reflectivity or a direction of the light reflection. In particular, the light reflection information may at least include light reflection information at the band of 550 nm and/or 850 nm.

Different materials or structures may have different light reflection information. For example, the light reflectivity of human skin differs from the light reflectivity of human skin mask, a human face in an electronic screen or an image. Further, for different parts of the human body, the light reflection angle may also be different and may be multi-dimensional. Other objects disguising a person, such as the electronic screen or photo showing a person, may have a light reflection angle significantly different from the living person.

Light reflection information may vary in different materials. In the process of capturing images, different feature regions may have different brightness. People having the same skin tone/color may have similar light reflection information. Thus, for the people having the same skin tone, the light reflection information may be processed, such as training the multi-dimensional light reflection information, to obtain a relatively uniform model capable of representing the real object. Accordingly, based on the light reflection information of different feature regions, whether the object is a living-body object may be determined.

In one embodiment, the light reflection information of at least one of the forehead, eyes, nose, lips, eyebrows, chin, ears, or face edge may be obtained.

In the Step 205, based on the light reflection information of the feature region, an eigenvector of the test object may be obtained. After obtaining the light reflection information, because the light reflectivity value and the light reflection direction are different, a multi-dimensional reflection eigenvector may be obtained. The multi-dimensional reflection eigenvector may be used as the eigenvector of the test object.

In one embodiment, the preset light spectrum may include the 550 nm and 850 nm bands. After the feature region of the test object is determined, 36 light reflectivity values may be selected from at least one of forehead, eyes, nose, lips, eyebrow, chin, ears, or face margins at the wavelength bands of 550 nm and 850 nm, respectively. That is, a total of 72 light reflectivity values may be selected. The selected 72 light reflectivity values may form the eigenvector of the face to be determined (i.e., the test object).

In the Step 206, the eigenvector may be compared with a standard model to determine whether the test object is a living-body object. In one embodiment, the standard model may include a reference eigenvector obtained through training the light reflection information of a reference target object (or simply a “reference object”) by support vector machine (SVM). The reference target object may include at least one of a one-dimensional (1D) planar object, an object displayed by an electronic device, a three-dimensional (3D) simulated object, or a real object.

The 1D planar object may include human figures and portraits, the object displayed by an electronic device may include characters in the electronic devices such as mobile phones and tablet computers, or characters projected by the electronic device. The 3D simulated objects may include characters such as wax figures or statues, and the real object may include real people.

In one embodiment, the standard model may be obtained by:

acquiring a multi-spectral image of a 1D plane object, an object displayed by the electronic device, a 3D simulated object, and/or a real object;

determining a feature region of the multi-spectral image; obtaining multi-dimensional light reflection information of the feature region, where the light multi-dimensional light reflection information contains the preset light spectrum;

converting the multi-dimensional light reflection information into a multi-dimensional eigenvector; and

entering the eigenvector into the support vector machine (SVM) and processing the entered eigenvector based on Radial Basis Function (RBF), thereby obtaining the reference eigenvector for the living-body detection, i.e., the model for living-body detection.

RBF may be a Gaussian function

$$R ( {x}_{p} - {c}_{i} ) = exp ( - \frac{1}{2 {δ}^{2}} {‖ {x}_{p} - {c}_{i} ‖}^{2} ) ,$$

and the output may be

$${y}_{j} = {\sum }_{i = 1}^{h} {w}_{ij} \times exp ( - \frac{1}{2 {δ}^{2}} {‖ {x}_{p} - {c}_{i} ‖}^{2} ) ,$$

j=1, 2, . . . , n, where, xₚ is the input eigenvector, cᵢ is the cluster center of the h training samples, i=1, 2, . . . , h, and δ is the expansion constant.

The RBF may be used as a “base” of the hidden unit to form a hidden layer space, and the entered eigenvector may be directly mapped to the hidden space. After the center point of the RBF is determined, the mapping relationship may be also determined. The mapping of the hidden layer space to the output space may be a linear mapping.

In one embodiment, after the standard model is determined, a first similarity value may be obtained through comparing the eigenvector of the test object with the reference eigenvector of the real object. When the first similarity value is greater than a corresponding preset first similarity threshold, the test object may be determined as a living-body object.

For example, the first preset similarity threshold of the family member may be determined as 95%. After the face model training is completed, the eigenvector of at least one of the foreground, eye, nose, lips, eyebrow, chin, ears, or face edge may be compared with the reference eigenvector of the real object. When a similarity value of 99% is obtained, the test object may be determined as a living-body object. When a similarity value of 80% is obtained, the test object may be determined as a non-living-body object.

In one embodiment, when the first similarity value is less than the first preset similarity threshold or when a second similarity value is greater than a corresponding second preset similarity threshold, the test object may be determined as a non-living-body object. The second preset similarity value may be a similarity value obtained by comparing the eigenvector with a reference eigenvector of the reference target object in a database. The reference target object in the database may include at least one of a 1D plane object, an object displayed by an electronic device, or a 3D simulated object.

For example, the first preset similarity threshold of the family member may be determined as 95% and the second preset similarity threshold may be determined as 95%. After the face model training is completed, the eigenvector of at least one of the forehead, eyes, nose, lips, eyebrow, chin, ears, or the face edge may be compared with the reference eigenvector of the real object. When a similarity value of 80% is obtained, the test object may be determined as a non-living-body object. For another example, after the face model training is completed, the eigenvector of at least one of the forehead, eyes, nose, lips, eyebrow, chin, ears, or the face edge may be compared with the reference eigenvector of the 1D plane object in the database, or the object displayed by the electronic device, or the 3D simulated object. When a similarity value of 98% is obtained, the test object may be determined as a living-body object.

In the disclosed embodiments, an image including a preset light spectrum may be acquired, a test object may be identified in the image, a feature region of the test object may be determined, light reflection information of the feature region may be obtained, and an eigenvector of the test object may be converted based on the light reflection information of the feature region. The eigenvector of the test object may be compared with a standard model to determine whether the test object is a living-body object. The detection time may be effectively reduced, and the detection efficiency may be improved.

The present disclosure provides another living-body detection method, which may be applied to a living-body detection device, such as a face recognition access and attendance system, a face recognition security door, and a face recognition payment system, etc. The face recognition payment system may include a smart electronic device having face recognition and payment functions, such as a smart phone, a computer, a tablet and other electronic devices.

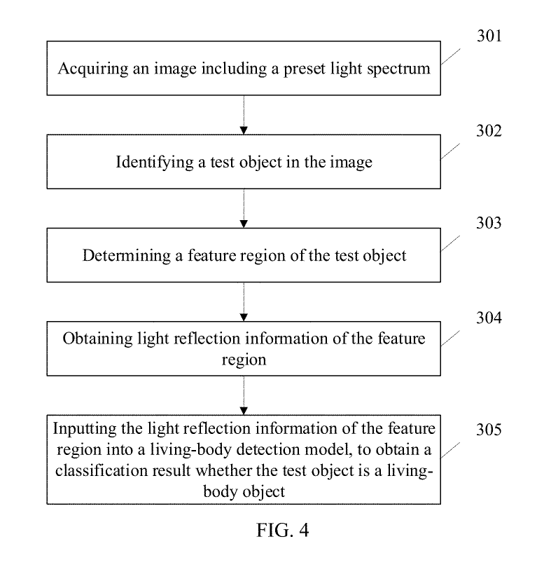

FIG. 4 illustrates a flow chart of another exemplary living-body detection method consistent with disclosed embodiments. As shown in FIG. 4, the method living-body detection may comprise:

Step 301: acquiring an image including a preset light spectrum;

Step 302: identifying a test object in the image;

Step 303: determining a feature region of the test object;

Step 304: obtaining light reflection information of the feature region; and

Step 305: inputting the light reflection information of the feature region into a living-body detection model, to obtain a classification result whether the test object is a living-body object.

In the Step 301, an image including a preset light spectrum may be acquired. The preset light spectrum may include, but not limited to, a band of 550 nm, 685 nm and/or 850 nm.

For the above-mentioned band of 550 nm, 685 nm and 850 nm, a special “W” mode may be observed in the skin reflection curve near the 550 nm band due to the special substances such as skin melanin. The observed “W” mode may be associated with the light reflectivity of the skin, which may effectively prompt the skin recognition (e.g., differentiate materials that mimic the color of human skin), and help to model and render human skin in a more realistic way. The band of 850 nm may be desired for living-body detection. The band of 685 nm may facilitate the classification of different ethnic groups.

In one embodiment, the image including the preset light spectrum may be acquired by a multispectral camera in a living-body detection device, such as a spectrum adjustable microelectromechanical system (MEMS) multispectral camera or a narrow-band multispectral imaging camera.

For example, the image including the preset light spectrum may be acquired by a camera in the living-body detection device. For example, a user may record a multispectral image containing at least the band of 550 nm and 850 nm through an electronic device. For another example, a face recognition access and attendance system or a face recognition security door may acquire a multispectral image including at least the band of 550 nm and 850 nm.

In one embodiment, to improve the detection efficiency, given the distance between an object to be determined and the living-body detection device satisfies a detection condition, for example, given the distance between the object to be determined and the living-body detection device is less than 1 meter (m), a camera in the living-body detection device camera may capture an image including a preset light spectrum, and deliver the captured image to a recognition system of the living-body detection device.

In the Step 302, a test object may be identified in the image. In one embodiment, the acquired image may contain various information such as human, animals, objects and backgrounds, and/or information representing such as human, animals, objects and backgrounds. Thus, after the image including the preset light spectrum is acquired, the recognition system in the living-body detection device may detect or identify the object in the image, to obtain a test object satisfying a detection condition.

For example, after the camera in the living-body detection device acquires the image which contains a human or an object representing a human, a dog and a background, the dog and the background in the image may be considered as useless objects. To obtain a useful object, various information in the image may be detected or identified to obtain the information of the human or the information of the object representing the human in the image.

In the Step 303, a feature region of the test object may be determined. In one embodiment, after the test object is identified in the image, a feature region of the test object may be determined. For example, the feature region may include the entire head region of the test object or a certain feature region of the head, such as the forehead, eyes, nose, lips, eyebrow, chin, ears, and face edge.

In the Step 304, light reflection information of the test object, e.g., light reflection information of the feature region, may be obtained. The light reflection information may include at least one of a value of the light reflectivity or a direction of the light reflection. In particular, the light reflection information may at least include light reflection information at the band of 550 nm and/or 850 nm.

Different materials or structures may have different light reflection information. For example, the light reflectivity of human skin differs from the light reflectivity of human skin mask, a human face in an electronic screen or an image. Further, for different parts of the human body, the light reflection angle may also be different and may be multi-dimensional. Other objects disguising a person, such as the electronic screen or photo showing a person, may have a light reflection angle significantly different from the living person.

Light reflection information may vary in different materials. In the process of capturing images, different feature regions may have different brightness. People having the same skin tone/color may have similar light reflection information. Thus, for the people having the same skin tone, the light reflection information may be processed, such as training the multi-dimensional light reflection information, to obtain a relatively uniform model capable of representing the real object. Accordingly, based on the light reflection information of different feature regions, whether the object is a living-body object may be determined.

In one embodiment, the light reflection information of at least one of the forehead, eyes, nose, lips, eyebrows, chin, ears, or face edge may be obtained.

In the Step 305, the light reflection information of the feature region may be inputted into a living-body detection model to obtain a classification result whether the test object is a living-body object. In particular, the living-body detection model may be obtained through training at least one of a neural model, a support vector machine (SVM) model and a classification, or regression tree (CART) model by machine learning.

Based on knowledge of statistics, information theory and cybernetics, as well as other non-mathematics, machine learning continues to learn knowledge and strategies from the experience of solving a type of problems. When facing similar problems, machine learning can solve the problems based on empirical knowledge and, meanwhile, accumulate new experience. In practical applications, deep learning algorithm may be adopted. In particular, machine learning can be applied to the field of artificial intelligence.

The neural model may include biological neural network models and artificial neural network models (ANNs). ANNs are algorithm mathematical models which simulate the behavior characteristics of an animal neural network and perform distributed parallel information processing. Relying on the complexity of the system, the relationship between a large number of internal nodes is adjusted to achieve the purpose of processing information. In particular, the development of RBF is also based on ANNs. Thus, RBF may be continuously trained on at least one of the forehead, eyes, nose, lips, eyebrow, chin, ears, or face edge to obtain a living-body detection model. The details may be referred to the Step 206, which are not repeated here.

In machine learning, SVM is a supervised learning model related to related learning algorithms. SVM may analyze data and identify patterns, which is desired for classification and regression analysis. Thus, SVM may be used for the classification and regression analysis of the reference eigenvector of the reference target object, thereby obtaining a living-body detection model.

CART learns by outputting a conditional probability distribution of a random variable Y given an input of a random variable X. Thus, the training may be performed by inputting the reference eigenvector of the reference target object to obtain a living-body detection model.

In the disclosed embodiments, an image including a preset light spectrum may be acquired, a test object may be identified in the image, a feature region of the test object may be determined, and light reflection information of the feature region may be obtained. The light reflection information of the feature region may be inputted into a living-body detection model to obtain a classification result whether the test object is a living-body object. The detection time may be effectively reduced, and the detection efficiency may be improved.

The present disclosure provides another living-body detection method, which may be applied to a living-body detection device, such as a face recognition access and attendance system, a face recognition security door, and a face recognition payment system, etc. The face recognition payment system may include a smart electronic device having face recognition and payment functions, such as a smart phone, a computer, a tablet and other electronic devices.

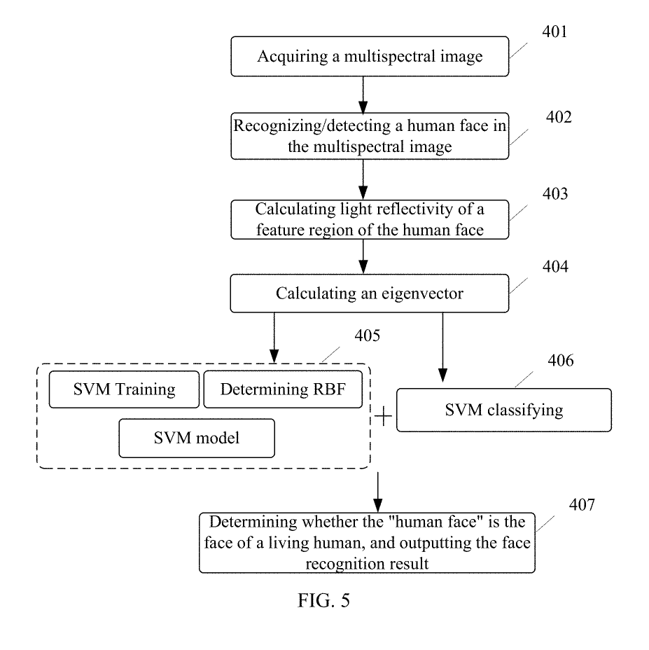

FIG. 5 illustrates a flow chart of another exemplary living-body detection method consistent with disclosed embodiments. As shown in FIG. 5, the method living-body detection may comprise:

Step 401: acquiring a multispectral image;

Step 402: recognizing/detecting a human face in the multispectral image;

Step 403: calculating light reflectivity of a feature region of the human face;

Step 404: calculating an eigenvector;

Step 405: training the eigenvector of the reference target object by SVM to obtain a standard model for living-body detection;

Step 406: classifying the SMV; and

Step 407: determining whether the “human face” is the face of a living human and outputting the face recognition result.

In the Step 401, a multispectral image may be acquired. In the training phase, multispectral images of a reference target object, such as a 1D planar object, an object displayed by electronic devices, a 3D simulated object and a real object, may be acquired. Then the Step 402 may be performed.

In the testing phase, a multispectral image of the environment may be acquired. As a “human face” to be determined approaches the living-body detection device, the living-body detection device may acquire a multispectral image containing the “human face” to be determined. Then the Step 402 may be performed.

In one embodiment, the multispectral image including the preset light spectrum may be acquired by a multispectral camera in a living-body detection device, such as a spectrum adjustable microelectromechanical system (MEMS) multi spectral camera or a narrow-band multispectral imaging camera.

In the Step 402, a human face in the multispectral image may be recognized or detected. In the Step 402, no matter in the training phase or the testing phase, after the reference target object or the multispectral image of the “human face” to be determined is collected, face detection or feature point extraction may be performed on the acquired multispectral image according to the face detection technology.

In the Step 403, the light reflectivity of a feature region of the human face may be calculated. In the Step 403, no matter in the training phase or the testing phase, after the facial feature points are extracted or the face detection is performed, the light reflectivity of the feature region of the “human face” may be calculated based on the multispectral image.

In one embodiment, the face feature of the extracted reference target object or the feature of the “human face” to be determined may be calibrated and optimized, after which the position and reflectivity of the face feature point may be obtained. In one embodiment, 36 face feature points with a fixed position may be determined, and then the light reflectivity corresponding to the band of 550 nm and 850 nm may be obtained respectively. That is, for one band, 36 face feature points correspond to 36 light reflectance values and, thus, a total 72 light reflectivity values may be obtained. The number of the face feature points is merely for illustrative purposes and is not intended to limit the scope of the present disclosure. In addition, the band of 550 nm and 850 nm are merely for illustrative purposes and are not intended to limit the scope of the present disclosure.

In the Step 404, an eigenvector may be calculated. In particular, after the light reflectivity of the reference target object or the “human face” to be determined is obtained, an eigenvector for the living-body detection may be calculated according to the obtained light reflectivity. For example, based on the obtained 72 light reflectivity values for the band of 550 nm and 850 nm, a 72-dimensional light reflectivity eigenvector may be obtained.

During the training phase, after the eigenvector is calculated, the Step 405 may be performed, during which the feature vector may be trained to obtain a final standard model for the living-body detection.

During the testing phase, after the eigenvector is calculated, the calculated eigenvector may be used as the final eigenvector for the living-body detection. The calculated eigenvector may be compared with a standard model obtained from training.

In the Step 405, the eigenvector of the reference target object may be trained by SVM, thereby obtaining a standard model for the living-body detection. In one embodiment, the calculated eigenvector may be entered into support vector machine (SVM), and the entered eigenvector may be processed based on Radial Basis Function (RBF), thereby obtaining a reference eigenvector for the living-body detection, i.e., the model for the living-body detection.

In particular, RBF may be a Gaussian function

$$R ( {x}_{p} - {c}_{i} ) = exp ( - \frac{1}{2 {δ}^{2}} {‖ {x}_{p} - {c}_{i} ‖}^{2} ) ,$$

and the output may be

$${y}_{j} = {\sum }_{i = 1}^{h} {w}_{ij} \times exp ( - \frac{1}{2 {δ}^{2}} {‖ {x}_{p} - {c}_{i} ‖}^{2} ) ,$$

j=1, 2, . . . , n, where, xₚ is the input eigenvector, cᵢ is the cluster center of the h training samples, i=1, 2, . . . , h, and δ is the expansion constant. Thus, through training the eigenvector of a reference target object by SVM, a standard model for living-body detection may be obtained.

In the Step 406, the SMV may be classified. The parameters of the SVM classifier may be adjusted by training a data set, and the trained data set may include a real face, a printed face, a 3D face mask, and a face on the screen of an electronic device, etc.

In the Step 407, whether the “human face” is the face of a living human may be determined, and the face recognition result may be outputted.

During the testing phase, after the eigenvector of the “human face” to be determined is obtained, based on the standard model trained for the living-body detection, whether the “human face” is the face of a living human may be determined, and the face recognition result may be outputted.

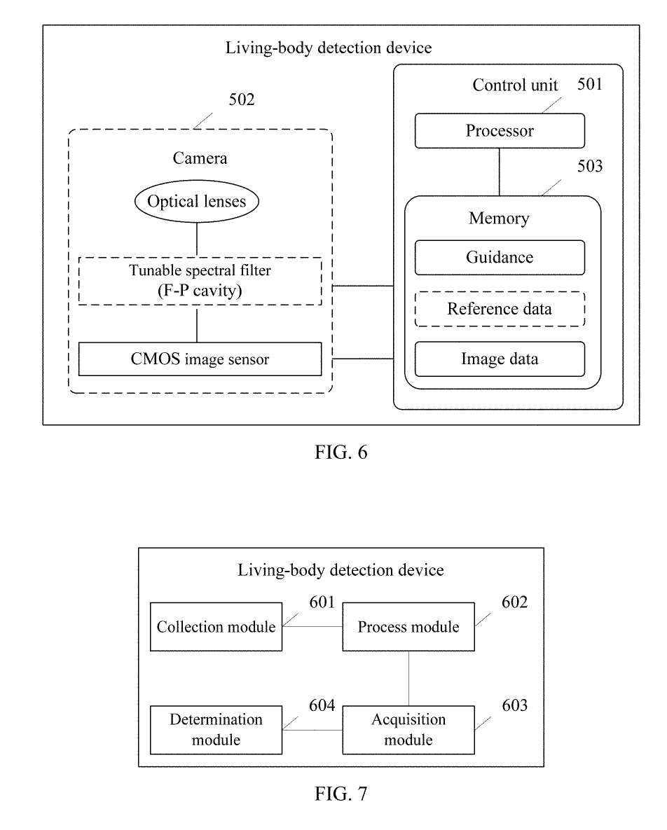

The present disclosure further provides a living-body detection system. FIG. 6 illustrates an exemplary living-body detection system consistent with disclosed embodiments. The living-body detection device may be implemented as various devices such as a smart phone and an access control system. As shown in FIG. 6, the living-body detection system may comprise a camera 502, and a control unit comprising at least one processor 501 and a memory 503.

The camera 502 (an image capturing device) may include a spectrum adjustable microelectromechanical system (MEMS) multispectral camera, a light field camera device or a narrow-band multispectral imaging camera. The camera 502 may include optical lenses, a tunable spectral filter, and an image sensor based on complementary metal oxide semiconductor (CMOS). Thus, the spectrum range obtained by the camera 502 may at least include 400 nm to 960 nm. The spectrum of the camera 502 may be adjusted by the tunable spectral filter during the detection.

The memory 503 (including a non-transitory computer-readable storage medium) may include volatile memory or non-volatile memory, or both volatile and non-volatile memory. Further, the memory 503 may include any appropriate types of memory.

The memory 503 may store various types of data to support the operation of the living-body detection device. For example, the various types of data may include: reference data for the living-body detection, image data and guidance. The reference data may include a standard model for the living-body detection after SVM training, and the image data may include an eigenvector of the “human face” to be determined.

In one embodiment, the disclosed living-body detection method may be applied to the processor 501. In another embodiment, the disclosed living-body detection method may be implemented by the processor 501 in a hardware only manner, or a combination of software and hardware.

For the implementation based on the hardware only, the processor 501 may include an integrated circuit chip with signal processing capabilities. The various steps of the disclosed living-body detection method may be implemented by an integrated logic circuit in the hardware in the processor 501. In one embodiment, the living-body detection device may comprise a built-in hardware decoding processor for implementing the disclosed living-body detection method, such as an application specific integrated circuit (ASIC), a complex programmable logic device (CPLD), and a field programmable gate array (FPGA), etc.

For the implementation based on the combination of software and hardware, the processor 501 may be implemented by a combination of general purpose processors and software modules. The software module may be located in a storage medium in the memory 503, where the storage medium may store a computer program capable of running on the processor 501.

When executing the computer program stored in the memory 503, the processor 501 may acquire an image including a preset light spectrum by a camera; identify a test object in the image and determine a feature region of the test object; obtain light reflection information of the feature region; and based on the light reflection information of the feature region, determine whether the test object is a living-body object.

Further, when executing the computer program stored in the memory 503, the processor 501 may acquire a multispectral image including a preset light spectrum by a spectrum adjustable microelectromechanical system (MEMS) multispectral camera or a narrow-band multispectral imaging camera. The multispectral image may include wavelength from 400 nm to 960 nm.

Further, when executing the computer program stored in the memory 503, the processor 501 may obtain an eigenvector of the test object based on the light reflection information of the feature region; and determine whether the test object is a living-body object through comparing the eigenvector with a standard model. In one embodiment, the standard model may include a reference eigenvector obtained through training the light reflection information of a reference target object by support vector machine (SVM). The reference target object may include at least one of a one-dimensional (1D) planar object, an object displayed by an electronic device, a three-dimensional (3D) simulated object, or a real object.

Further, when executing the computer program stored in the memory 503, the processor 501 may compare the eigenvector with the reference eigenvector of the real object to obtain a first similarity value. When the first similarity value is greater than a corresponding preset first similarity threshold, the test object may be determined as a living-body object.

Further, when executing the computer program stored in the memory 503, when the first similarity value is less than the first preset similarity threshold or when a second similarity value is greater than a corresponding second preset similarity threshold, the processor 501 may determine the test object as a non-living-body object. The second preset similarity value may be a similarity value obtained by comparing the eigenvector of the test object with a reference eigenvector of the reference target object in the database.

Further, when executing the computer program stored in the memory 503, the processor 501 may input the light reflection information of the feature region into a living-body detection model, to obtain a classification result whether the test object is a living-body object. In particular, the living-body detection model may be obtained through training at least one of a neural model, a support vector machine (SVM) model and a classification, or regression tree (CART) model by machine learning.

The present disclosure also provides another living-body detection device. FIG. 7 illustrates another exemplary living-body detection system consistent with disclosed embodiments. As shown in FIG. 7, the living-body detection device may comprise a collection module 601, a process module 602, an acquisition module 603, and a determination module 604.

The collection module 601 may acquire an image including a preset light spectrum. The process module 602 may identify a test object in the image and determine a feature region of the test object. The acquisition module 603 may obtain light reflection information of the feature region. The determination module 604 may determine whether the test object is a living-body object based on the light reflection information of the feature region.

Further, the collection module 601 may acquire a multispectral image. The multispectral wavelength may include 400 nanometers to 960 nanometers.

Further, the determination module 604 may obtain an eigenvector of the test object based on the light reflection information of the feature region; and compare the eigenvector with a standard model to determine whether the test object is a living-body object. In one embodiment, the standard model may include a reference eigenvector obtained through training the light reflection information of a reference target object by support vector machine (SVM). The reference target object may include at least one of a one-dimensional (1D) planar object, an object displayed by an electronic device, a three-dimensional (3D) simulated object, or a real object.

Further, the determination module 604 may compare the eigenvector with the reference eigenvector of the real object to obtain a first similarity value. When the first similarity value is greater than a corresponding preset first similarity threshold, the determination module 604 may determine the test object as a living-body object.

Further, when the first similarity value is less than the first preset similarity threshold or when a second similarity value is greater than a corresponding second preset similarity threshold, the determination module 604 may determine the test object as a non-living-body object. The second preset similarity value may be a similarity value obtained by comparing the eigenvector of the test object with a reference eigenvector of the reference target object in the database.

Further, the determination module 604 may input the light reflection information of the feature region into a living-body detection model, to obtain a classification result whether the test object is a living-body object. In particular, the living-body detection model may be obtained through training at least one of a neural model, a support vector machine (SVM) model, or a classification and regression tree (CART) model by machine learning.

In the disclosed embodiments, an image including a preset light spectrum may be acquired, a test object may be identified in the image, a feature region of the test object may be determined, and light reflection information of the feature region may be obtained. Based on the light reflection information of the feature region, whether the test object is a living-body object may be determined. The disclosed living-body detection method and device are featured with strong practicability, real-time identification and high accuracy. The detection time may be effectively reduced, and the detection efficiency may be improved.

In addition, in the disclosed embodiments, a spectrum adjustable microelectromechanical system (MEMS) multispectral camera may be adopted, which realizes a miniaturization and low-cost living-body detection.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A method of detecting a target object, comprising:
acquiring an image of a test object using a preset light spectrum;
identifying the test object from the acquired image of the test object;
determining a feature region of the test object from the acquired image of the test object;
obtaining light reflection information of the test object; and
detecting whether the test object is the target object based on the feature region and the light reflection information.

2. The method according to claim 1, wherein acquiring the image of the test object comprises:
acquiring a multispectral image having a spectrum including wavelength from 400 nm to 960 nm.

3. The method according to claim 1, wherein detecting whether the test object is the target object comprises:
obtaining an eigenvector of the test object based on the light reflection information; and
comparing the eigenvector of the test object with a standard model to determine whether the test object is the target object.

4. The method according to claim 3, wherein:
the standard model includes a reference eigenvector obtained through training light reflection information of a reference object by support vector machine (SVM); and
the reference object includes at least one selected from the group consisting of a one-dimensional (1D) planar object, an object displayed by an electronic device, a three-dimensional (3D) simulated object, and a real object.

5. The method according to claim 4, wherein comparing the eigenvector with the standard model to determine whether the test object is the target object comprises:
comparing the eigenvector of the test object with the reference eigenvector of the real object to obtain a first similarity value; and
in response to the first similarity value being greater than a first preset similarity threshold, determining that the test object is the target object.

6. The method according to claim 5, wherein comparing the eigenvector with the standard model to determine whether the test object is the target object further comprises:
comparing the eigenvector of the test object with the reference eigenvector of the reference object in a database to obtain a second similarity value; and
in response to the first similarity value being less than the first preset similarity threshold or in response to the second similarity value being greater than a second preset similarity threshold, determining that the target object is not the target object.

7. The method according to claim 1, wherein detecting whether the test object is the target object comprises:
inputting the light reflection information into a target detection model to obtain a classification result whether the test object is the target object, the target detection model being obtained through training a model by machine learning, the model being at least one selected from the group consisting of a neural model, a support vector machine (SVM) model, and a classification and regression tree (CART) model by machine learning.

8. A detection device configured to detect a target object, the detection device comprising:
an image capturing device configured to acquire an image of a test object using a preset light spectrum and obtain light reflection information of the test object; and
a processor coupled to the image capturing device and configured to:
identify the test object from the acquired image of the test object;
determine a feature region of the test object from the acquired image of the test object;
obtain light reflection information of the test object; and
detect whether the test object is the target object based on the feature region and the light reflection information.

9. The device according to claim 8, wherein the processor is further configured to:
acquire a multispectral image having a spectrum including wavelength from 400 nm to 960 nm.

10. The device according to claim 8, wherein the processor is further configured to:
obtain an eigenvector of the test object based on the light reflection information; and
compare the eigenvector of the test object with a standard model to determine whether the test object is the target object.

11. The device according to claim 10, wherein:
the standard model includes a reference eigenvector obtained through training light reflection information of a reference object by support vector machine (SVM); and
the reference object includes at least one selected from the group consisting of a one-dimensional (1D) planar object, an object displayed by an electronic device, a three-dimensional (3D) simulated object, and a real object.

12. The device according to claim 11, wherein the processor is further configured to:
compare the eigenvector of the test object with the reference eigenvector of the real object to obtain a first similarity value; and
in response to the first similarity value being greater than a first preset similarity threshold, determine that the test object is the target object.

13. The device according to claim 8, wherein the processor is further configured to:
compare the eigenvector of the test object with the reference eigenvector of the reference object in a database to obtain a second similarity value; and
in response to the first similarity value being less than the first preset similarity threshold or in response to the second similarity value being greater than a second preset similarity threshold, determine that the target object is not the target object.

14. The device according to claim 8, wherein the processor is further configured to:
input the light reflection information into a target detection model to obtain a classification result whether the test object is the target object, the target detection model being obtained through training a model by machine learning, the model being at least one selected from the group consisting of a neural model, a support vector machine (SVM) model, or a classification and regression tree (CART) model.

15. A non-transitory computer-readable medium storing a computer program that, when being executed by a processor, causes the processor to perform a method of detecting a target object, the method comprising:
acquiring an image of a test object using a preset light spectrum;
identifying the test object from the acquired image of the test object;
determining a feature region of the test object from the acquired image of the test object;
obtaining light reflection information of the test object; and
detecting whether the test object is the target object based on the feature region and the light reflection information.

16. The non-transitory computer-readable medium according to claim 15, wherein acquiring the image of the test object comprises:
acquiring a multispectral image having a spectrum including wavelength from 400 nm to 960 nm.

17. The non-transitory computer-readable medium according to claim 15, wherein detecting whether the test object is the target object comprises:
obtaining an eigenvector of the test object based on the light reflection information; and
comparing the eigenvector of the test object with a standard model to determine whether the test object is the target object.

18. The non-transitory computer-readable medium according to claim 17, wherein:
the standard model includes a reference eigenvector obtained through training light reflection information of a reference object by support vector machine (SVM); and
the reference object includes at least one selected from the group consisting of a one-dimensional (1D) planar object, an object displayed by an electronic device, a three-dimensional (3D) simulated object, and a real object.

19. The non-transitory computer-readable medium according to claim 18, wherein comparing the eigenvector with the standard model to determine whether the test object is the target object comprises:
comparing the eigenvector of the test object with the reference eigenvector of the real object to obtain a first similarity value; and
in response to the first similarity value being greater than a first preset similarity threshold, determining that the test object is the target object.

20. The non-transitory computer-readable medium according to claim 19, wherein comparing the eigenvector with the standard model to determine whether the test object is the target object further comprises:
comparing the eigenvector of the test object with the reference eigenvector of the reference object in a database to obtain a second similarity value; and
in response to the first similarity value being less than the first preset similarity threshold or in response to the second similarity value being greater than a second preset similarity threshold, determining that the target object is not the target object.
